(19) United States
(12) Patent Application Publication
(10) Pub. No.: US 2018/0039518 A1
(43) Pub. Date: Feb. 8, 2018

(54) ARBITRATING ACCESS TO A RESOURCE THAT IS SHARED BY MULTIPLE PROCESSORS

(71) Applicant: KnuEdge Incorporated, San Diego, CA (US)

(72) Inventors: Ramkumar Jayaseelan, Austin, TX (US); Sadagopan Srinivasan, Austin, TX (US); Thomas Andrew Hartin, Austin, TX (US)

(21) Appl. No.: 15/226,384

(22) Filed: Aug. 2, 2016

(51) Int. Cl. G06F 9/50; G06F 9/455; G06F 9/52

(52) U.S. Cl. CPC G06F 9/5011; G06F 9/526; G06F 9/45558; G06F 2009/45579

(57) ABSTRACT

In an illustrative example, a system includes a resource and a first processor. The first processor is configured to access the resource based on a first physical address space and to generate a request for access to the resource. The request has a first format. The system further includes a second processor configured to access the resource based on a second physical address space. The system also includes a device coupled to the resource and to the first processor. The device is configured to receive the request, to generate a message having a second format based on the request, to send the message to the resource, and to provide a reply to the request to the first processor.

### FIELD

This disclosure is generally related to electronic devices and more particularly to operation of processors included in electronic devices.

### BACKGROUND

Electronic devices may include one or more processors that execute instructions to perform operations. In a multiprocessor configuration, an electronic device may include multiple processors that may each execute instructions to increase processing speed, processing capability, or both.

As a number of processors increases, certain device resources may be “shared” between the processors to reduce device size, cost, or complexity. For example, instead of providing a separate memory for each of the processors, the processors may “share” a memory. Sharing a resource may result in conflicts in some cases. For example, a processor may modify data stored at the memory, and another processor may access a prior (or “stale”) copy of the data prior to updating of the data.

In some devices, a processor may execute a hypervisor that controls access to a shared resource. The hypervisor may virtualize the shared resource. By virtualizing the shared resource, the processor may appear to “own” the shared resource (e.g., certain accesses to the shared resource by other processors may not be visible to the processor). Use of a hypervisor consumes device resources and may slow processor performance in some cases (e.g., by delaying other tasks to be performed by the processor).

Further, the hypervisor and the processor may need to be included in a common coherency domain to enable the hypervisor to determine when to control access to the shared resource. As an example, the hypervisor may be included in a common coherency domain as the processor in order to detect a message from the shared resource to the processor. In this example, if the hypervisor is not included in a common coherency domain as the processor, the hypervisor may not “see” the message from the shared resource. Including the hypervisor and the processor in a common coherency domain may reduce design flexibility in some cases.

### SUMMARY

In an illustrative example, an electronic device includes a device that is coupled to a shared resource that is accessed by multiple processors, such as a first processor and a second processor. The device is configured to control (e.g., arbitrate) access to the shared resource. For example, the device is configured to receive requests from the first processor via a coherent fabric (e.g., a bus) and to reformat the requests based on a second format associated with a message passing interface used to access the shared resource.

In some implementations, the device is configured to emulate one or more aspects of the shared resource. For example, the device may include a first set of configuration registers that “mirror” a second set of configuration registers of the shared resource. A processor may access the first set of configuration registers (e.g., using a request having the first format), and the device subsequently “propagates” the request to the shared resource by sending a message having the second format to the shared resource via the message passing interface. As a result, operation of the processor may be simplified, such as by reducing or avoiding reliance on a hypervisor to control access to the shared resource. In some cases, the processor may be “unaware” that the shared resource is accessed by one or more other processors (e.g., a second processor of a second coherency domain), which may be improve processor efficiency as compared to executing a hypervisor to share access to the resource with one or more other processors. In some implementations, a hypervisor executed by the processor may be included in a different coherency domain than the processor. Illustrative aspects, examples, and advantages of the disclosure are described further below with reference to the drawings.

### BRIEF DESCRIPTION OF THE DRAWINGS

FIG. 1 is a block diagram of an illustrative example of a system that includes a device configured to arbitrate access to a resource by a set of processors.

FIG. 2 is a block diagram of another illustrative example of a system that includes the device of FIG. 1.

FIG. 3 is a block diagram of an illustrative example of an integrated circuit that includes the device of FIG. 1.

FIG. 4 is a block diagram of a computing device that includes the integrated circuit of FIG. 3.

FIG. 5 is a flow chart of an illustrative example of a method of operation of a device, such as the device of FIG. 1.

FIG. 6 is a flow chart of an illustrative example of a method of operation of a processor, such as one or more of the processors of FIG. 1.

### DETAILED DESCRIPTION

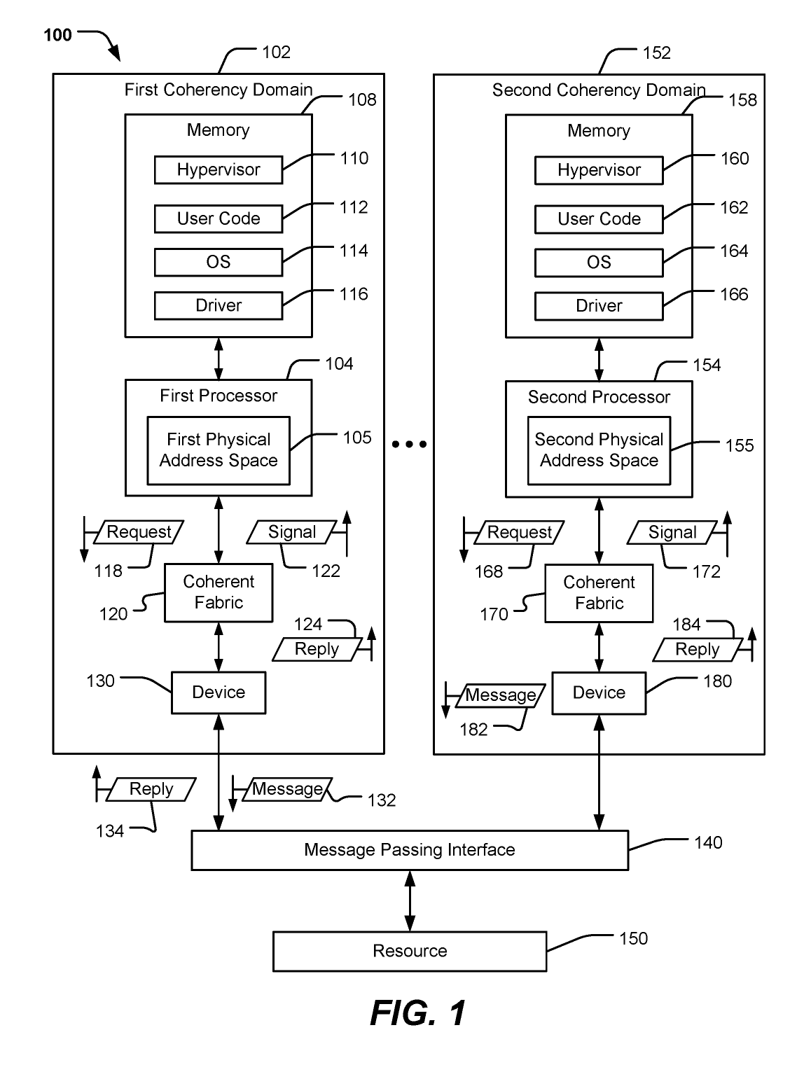

FIG. 1 depicts an illustrative example of a system 100. The system 100 includes a first processor 104, a second processor 154, a device 130, a device 180, and a resource 150. The first processor 104 may be coupled to the device 130 via a coherent fabric 120, and the second processor 154 may be coupled to the device 180 via a coherent fabric 170. The devices 130, 180 may be coupled to the resource 150 via a message passing interface 140.

The first processor 104 is configured to access the resource 150 using a first physical address space 105, and the second processor 154 is configured to access the resource 150 using a second physical address space 155. In some cases, the first physical address space 105 may be disjoint with respect to the second physical address space 155. For example, in some circumstances, a particular address included in both of the physical addresses spaces 105, 155 may refer to different locations within the resource 150 depending on whether the particular address is indicated by the first processor 104 or by the second processor 154.

To further illustrate, the system 100 may include multiple coherency domains. For example, the first processor 104 is included in a first coherency domain 102, and the second processor 154 is included in a second coherency domain 152. Components included in a coherency domain may “see” memory access operations similarly. To illustrate, because the processors 104, 154 are included in different coherency domains, certain aspects of the resource 150 may be “viewed” differently by the processors 104, 154. As used herein, a coherency domain may refer to a set of components that use a common set of physical addresses (e.g., the first physical address space 105 or the second physical address space 155) associated with a shared resource, such as the resource 150. In some implementations, each component within the first coherency domain 102 may use a common coherence protocol (e.g., a cache coherency protocol), and each component within the second coherency domain 152 may use a common coherence protocol (e.g., another cache coherency protocol). In some cases, the first processor 104 may access a first copy of information that is different than (i.e., not coherent with respect to) a second copy of the information accessed by the second processor 154 as a result of the processors 104, 154 being included in different coherency domains 102, 152.

The first processor 104 is coupled to a memory 108. The memory 108 stores instructions, such as user code 112, an operating system 114, and a driver 116. The second processor 154 is coupled to a memory 158, and the memory 158 stores user code 162, an operating system 164, and a driver 166. The memory 108 may optionally store a hypervisor 110 executable by the first processor 104, and the memory 158 may optionally store a hypervisor 160 executable by the second processor 154. In other implementations, the hypervisors 110, 160 may be omitted from the system 100.

The coherent fabrics 120, 170 may each include a physical structure, such as a bus. As used herein, a coherent fabric may refer to an interface (e.g., an on-chip interface, a high-speed interface, or another interface) that is accessible to multiple devices (e.g., cores of the processors 104, 154) using a common protocol. The coherent fabrics 120, 170 may each include an interconnect, such as an on-chip interconnection between devices (such as cores of the first processor 104 or cores of the second processor 154) that enables communication of information between the devices. The coherent fabrics 120, 170 may each include a physical interface, a logical interface, or both. For example, the coherent fabrics 120, 170 may each include a bus that is configured to operate in compliance with a particular bus protocol.

In an illustrative example, the message passing interface 140 may be a non-coherent interface. For example, the message passing interface 140 may be an input/output (I/O) interface that is non-coherent with respect to the coherent fabrics 120, 170. The message passing interface 140 may be accessible to (e.g., may be coupled to) multiple coherency domains, such as the coherency domains 102, 152. In an illustrative implementation, an integrated circuit includes the first coherency domain 102, and the message passing interface 140 corresponds to an I/O interface of the integrated circuit. Depending on the particular implementation, the second coherency domain 152 may be included in the integrated circuit or in another integrated circuit that is coupled to the integrated circuit. The message passing interface 140 may include a physical interface, a logical interface, or both. For example, the message passing interface 140 may include a bus that is configured to operate in compliance with a particular bus protocol.

The resource 150 may be “shared” by the processors 104, 154. For example, the resource 150 may include one or more of a shared memory, a solid state drive (SSD), a hard disk drive (HDD), a hybrid drive, a network interface controller (NIC), a direct memory access (DMA) resource, or a configuration register, or another component, as illustrative examples.

The device 130 may be configured to emulate the resource 150. For example, the device 130 may include a “stub” device that is configured to emulate one or more aspects of the resource 150. As used herein, a “stub” device may replicate one or more aspects of another device, such as the resource 150. The device 130 is configured to enable (e.g., arbitrate) access to the resource 150 by the first processor 104, and the device 180 is configured to enable (e.g., arbitrate) access to the resource 150 by the second processor 154. The device 130 may also be referred to herein as a stub or as a resource arbiter stub.

During operation, the first processor 104 is configured to generate a request 118 for access to the resource 150. The request 118 has a first format associated with the coherent fabric 120. For example, the request 118 may have a first packet size associated with the first format. Alternatively or in addition, the request 118 may comply with a first command protocol associated with the first format.

The device 130 is configured to receive the request 118 (e.g., via the coherent fabric 120). The device 130 is configured to generate a message 132 based on the request 118. The message 132 has a second format. For example, the message 132 may have a second packet size associated with the second format, and the second packet size may be different than the first packet size.

Alternatively or in addition, the device 130 may be configured to perform a command remapping operation. For example, the message 132 may comply with a second command protocol associated with the second format, and the second command protocol may be different than the first command protocol. As an illustrative example, the first format may specify that a request for read access or write access is to include a first opcode, and the second format may specify that a request for read access or write access is to include a second opcode different than the first opcode. As another example, the first format may specify a first message size, and the second format may specify a second message size different than the first message size.

In some circumstances, the device 130 may send a signal 122 to the first processor 104 via the coherent fabric 120 in response to the request 118. To illustrate, the signal 122 may indicate that the request 118 is completed or is being processed (even if the request 118 is not completed or is not being processed). To illustrate, the request 118 may be generated by a first core of the first processor 104. If a second core of the first processor 104 is accessing the resource 150 when the device 130 receives the request 118, instead of notifying the first processor 104 that the request 118 has been delayed, the device 130 may provide the signal 122 to indicate that the request 118 has been or is being processed. As another illustrative example, if the second processor 154 is accessing the resource 150 when the device 130 receives the request 118, instead of notifying the first processor 104 that the request 118 has been delayed, the device 130 may provide the signal 122 to indicate that the request 118 has been or is being processed. In this example, the signal 122 may reduce or avoid instances of the first processor 104 stalling while waiting for the request 118 to be processed. The device 130 may access the resource 150 based on the request 118 after access by the second processor 154 is complete.

In some cases, the signal 122 may indicate that handling of the request 118 is delayed, such as if the device 130 is currently handling another request. In this case, the signal 122 may correspond to a trap signal. In some implementations, the first processor 104 is configured to execute the driver 116 to receive the signal 122 from the device 130. For example, the driver 116 may be executable by the first processor 104 to receive the signal 122, to decode the signal 122, to initiate one or more operations based on the signal 122, or a combination thereof

As an illustrative example, the driver 116 may be executable by the first processor 104 to cause the first processor 104 to enter a sleep mode in response to the signal 122. The signal 122 may indicate to the operating system 114 that the first processor 104 is to wait to access the resource 150, such as if the resource 150 is busy handling another request. Alternatively or in addition, the signal 122 may indicate that the first processor 104 is to perform a context switch while waiting to access the resource 150, such as by switching execution to another application while waiting to access the resource 150. In some implementations, execution of the driver 116 may use fewer resources of the first processor 104 than execution of the hypervisor 110 (e.g., the driver 116 may include less code than the hypervisor 110, may be executed using fewer clock cycles than the hypervisor 110, or both).

The device 130 is configured to send the message 132 to the resource 150 (e.g., via the message passing interface 140). The resource 150 is configured to generate a reply 134 based on the message 132. As a non-limiting illustrative example, the resource 150 may include a memory, the request 118 may indicate data to be read from the memory, and the reply 134 may include the read data.

The device 130 is configured to generate a reply 124 based on the reply 134 and to provide the reply 124 to the first processor 104 (e.g., via the coherent fabric 120). For example, the device 130 may modify (e.g., “reformat”) the reply 134 from the second format to the first format to generate the reply 124. To illustrate, the reply 134 may have a second packet size associated with the second format, and the reply 124 may have a first packet size associated with the first format. Alternatively or in addition, the reply 134 may comply with a second command protocol associated with the second format, and reply 124 may comply with a first command protocol associated with the first format.

The device 130 is configured to provide the reply 124 to the first processor 104. For example, the device 130 may be configured to send the reply to the first processor 104 via the coherent fabric 120. The first processor 104 is configured to receive the reply 124 from the device 130. As a non-limiting illustrative example, the reply 124 may include data read from the resource 150, and the first processor 104 may use the data during execution of the user code 112.

In some cases, operation of the second processor 154 and the device 180 may be as described with reference to operation of the first processor 104 and the device 130. To illustrate, the second processor 154 may be configured to send a request 168 to the device 180 for access to the resource 150. The request 168 may have a particular format, such as the first format or a format that is different than the first format (e.g., a third format). In this case, the device 180 may be configured to reformat the request 168 to the second format to generate a message 182. In some circumstances, the device 180 may provide a signal 172 to the second processor 154. The second processor 154 may execute the driver 166 to receive the signal 172, to decode the signal 172, to initiate one or more operations based on the signal 172, or a combination thereof. The device 180 may be further configured to reformat a reply to the message 182 from the resource 150 to generate a reply 184. The device 180 may provide the reply 184 to the second processor 154 (e.g., via the coherent fabric 170).

In some implementations, the devices 130, 180 are configured to combine (e.g., aggregate) packets, to separate (e.g., fragment) packets, or both. For example, the device 130 may be configured to selectively combine and separate packets based on the first size (e.g., a packet size) associated with the coherent fabric 120 and based on the second size (e.g., a packet size) associated with the message passing interface 140.

As a non-limiting illustrative example, the message passing interface 140 may comply with a standard that specifies the second size, such as a Peripheral Component Interconnect Express (PCIe) standard, a Non-Volatile Memory Express (NVMe) standard, or both. The coherent fabric 120 may comply with a standard that specifies the first size, such as a standard associated with a NIC, as an illustrative example. The first size may be 128 bytes (B) and the second size may be 64 B, as an illustrative example. To further illustrate, the coherent fabric 120 may include a bus configured to use a greater packet size as compared to the message passing interface 140 in order to increase bandwidth available for communications to and from the first processor 104. The second size may correspond to a size of a cache line of a cache, as an illustrative example.

The device 130 may be configured to divide (e.g., fragment) a packet (e.g., the request 118) into multiple packets. In this example, the message 132 may include multiple packets, and the device 130 may provide the multiple packets to the resource 150 sequentially. The device 130 may be further configured to combine (e.g., aggregate) multiple packets having the second size to generate a packet (e.g., the reply 124) having the first size. For example, the device 130 may combine the reply 134 with one or more other replies from the resource 150 to generate a packet and may provide the packet to the first processor 104. Further, although the first size has been described as being greater than the second size, in other examples, the first size may be less than the second size.

Although the example of FIG. 1 depicts that the hypervisor 110 is included in the first coherency domain 102, in other implementations, the hypervisor 110 may be included in another coherency domain (other than the first coherency domain 102). Alternatively or in addition, the hypervisor 160 may be included in a coherency domain other than the second coherency domain 152. To illustrate, using the device 130 to control access to the resource 150 may “free” the hypervisors 110, 160 from needing to detect communications between the processors 104, 154 and the resource 150. As a result, the hypervisor 110 need not be included in the first coherency domain 102, and the hypervisor 160 need not be included in the second coherency domain 152.

To further illustrate certain aspects of the disclosure, in some cases, the hypervisor 110 may enable the operating system 114 to share certain resources with the operating system 164 of the second processor 154, such as by virtualizing a shared resource (e.g., the resource 150) so that the shared resource appears to “belong” to each of the operating systems 114, 164. In some cases, the first processor 104 may be configured to execute the hypervisor 110 to directly access the shared resource, such as by using the hypervisor 110 to determine a message format. In certain devices, if a hypervisor is not used to access a shared resource, then an operating system may be recompiled to enable the operating system to access the shared resource (e.g., by determining a message format). In accordance with the disclosure, the device 130 may enable the first processor 104 to access the resource 150 without using the hypervisor 110 and without recompiling the operating system 114 (e.g., the device 130 may be “transparent” to the operating system 114). For example, the device 130 may determine a message format so that the resource 150 is accessible by the first processor 104 without use of the hypervisor 110 and without recompiling of the operating system 114. The operating system 114 may be “unaware” that the resource 150 is shared with one or more other processors, such as the second processor 154.

One or more aspects of FIG. 1 may improve processor performance. For example, by reformatting the request 118 from the first format to the second format to generate the message 132, the device 130 may enable the first processor 104 to access the resource 150 without use of the hypervisor 110 (e.g., without using the hypervisor 110 to determine a format of the message 132). Further, by reformatting the request 118 from the first format to the second format to generate the message 132, the device 130 may enable the first processor 104 to access the resource 150 without recompiling the operating system 114 (e.g., without recompiling the operating system 114 to determine a format of the message 132).

Further, one or more aspects may enable the processors 104, 154 to be included in different coherency domains 102, 152 and to use different message formats. For example, the devices 130, 180 may reformat (or “translate”) messages from the processors 104, 154 to enable the processors 104, 154 to request access to the resource 150 using different message formats.

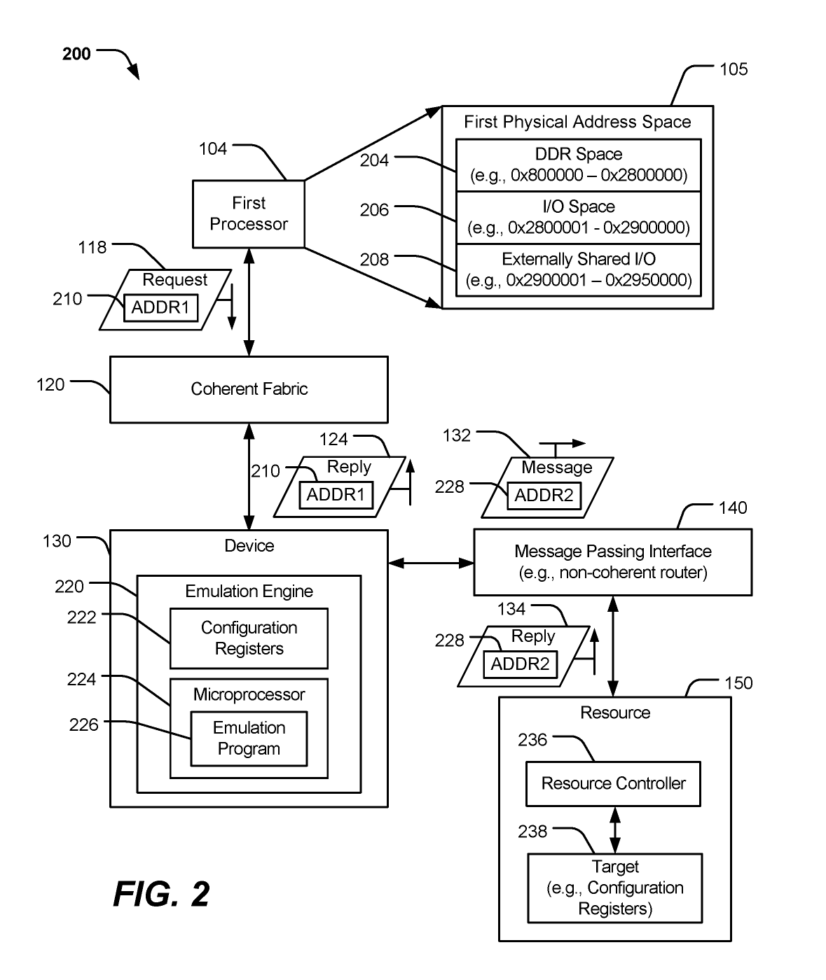

FIG. 2 depicts an illustrative example of a system 200. The system 200 may include one or more components described with reference to FIG. 1. For example, the system 200 includes the first processor 104, the coherent fabric 120, the device 130, the message passing interface 140, and the resource 150.

In the example of FIG. 2, the first processor 104 is configured to access the resource 150 based on the first physical address space 105. The first physical address space 105 may indicate one or more address ranges, such as a double data rate (DDR) address range 204, an input/output (I/O) address range 206, and an externally shared I/O address range 208. In an illustrative example, the externally shared I/O address range 208 corresponds to a set of physical addresses of the resource 150.

In the illustrative example of FIG. 2, the device 130 is configured to perform a remapping operation to enable the first processor 104 to access the resource 150 based on the first physical address space 105. For example, FIG. 2 depicts that the request 118 may indicate a first address 210 (e.g., a physical address of the resource 150). In some examples, the first address 210 may be included in the externally shared I/O address range 208. The device 130 may be configured to remap the first address 210 to generate a second address 228 included in the message 132. The message 132 may include a device identifier (e.g., of the first processor 104) determined by the device 130.

To further illustrate, the processors 104, 154 may use of disjoint physical address spaces. For example, in some cases, the first address 210 may refer to multiple locations depending on whether the first address 210 is used by the first processor 104 or by the second processor 154. The device 130 may be configured to remap the first address 210 to the second address 228 in response to a request from the first processor 104.

FIG. 2 also illustrates that the reply 134 may optionally indicate the second address 228. The device 130 may remap the second address 228 to the first address 210. The reply 124 may indicate the first address 210.

The resource 150 may include a target 238. As a non-limiting illustrative example, the target 238 may include DMA configuration registers associated with the addresses 210, 228. In some implementations, a resource controller 236 may be coupled to or may be included in the resource 150. As a non-limiting illustrative example, the resource controller 236 may include a memory controller, a DMA controller, or a disk controller.

In the illustrative example of FIG. 2, the device 130 is configured to emulate the resource 150 using one or more hardware components. For example, the device 130 may include an emulation engine 220, and the emulation engine 220 may include one or more hardware components, such as a first set of configuration registers 222 corresponding to a second set of configuration registers of the target 238. The first set of configuration registers 222 and the second set of configuration registers of the target 238 may include DMA configuration registers, as an illustrative example. The first processor 104 may be configured to access (e.g., to program) the first set of configuration registers 222 using the request 118, and the device 130 may be configured to access (e.g., to program) the second set of configuration registers of the target 238 by sending the message 132 in response to programming the first set of configuration registers 222.

Alternatively or in addition, the device 130 may include a microprocessor 224 configured to execute instructions (e.g., an emulation program 226) to emulate one or more operations of the resource 150. For example, the microprocessor 224 may execute the emulation program 226 to generate the message 132 in response to the request 118 and to generate the reply 124 in response to the reply 134.

In some implementations, the resource controller 236 may be configured to broadcast a message to multiple processors, such as the processors 104, 154. For example, the resource controller 236 may determine (or change) a message size used to access the resource 150, such as a maximum transmission unit (MTU). The resource controller 236 may be configured to broadcast a message indicating the message size to the processors 104, 154. The message may be sent to the first processor 104 via the device 130. Alternatively or in addition, the resource controller 236 may determine (or change) an address associated with the resource 150, such as an Internet Protocol (IP) address. The resource controller 236 may be configured to broadcast a message indicating the address to the processors 104, 154. The message may be sent to the first processor 104 via the device 130. Alternatively or in addition, the resource controller 236 may initiate a power down operation at the resource 150. The resource controller 236 may be configured to broadcast a message indicating the resource 150 is to power down. The message may be sent to the first processor 104 via the device 130.

The example of FIG. 2 illustrates that the device 130 may perform one or more operations to improve device performance, such as by performing an address remapping operation. By performing an address remapping operation, the processors 104, 154 may be included in different coherency domains.

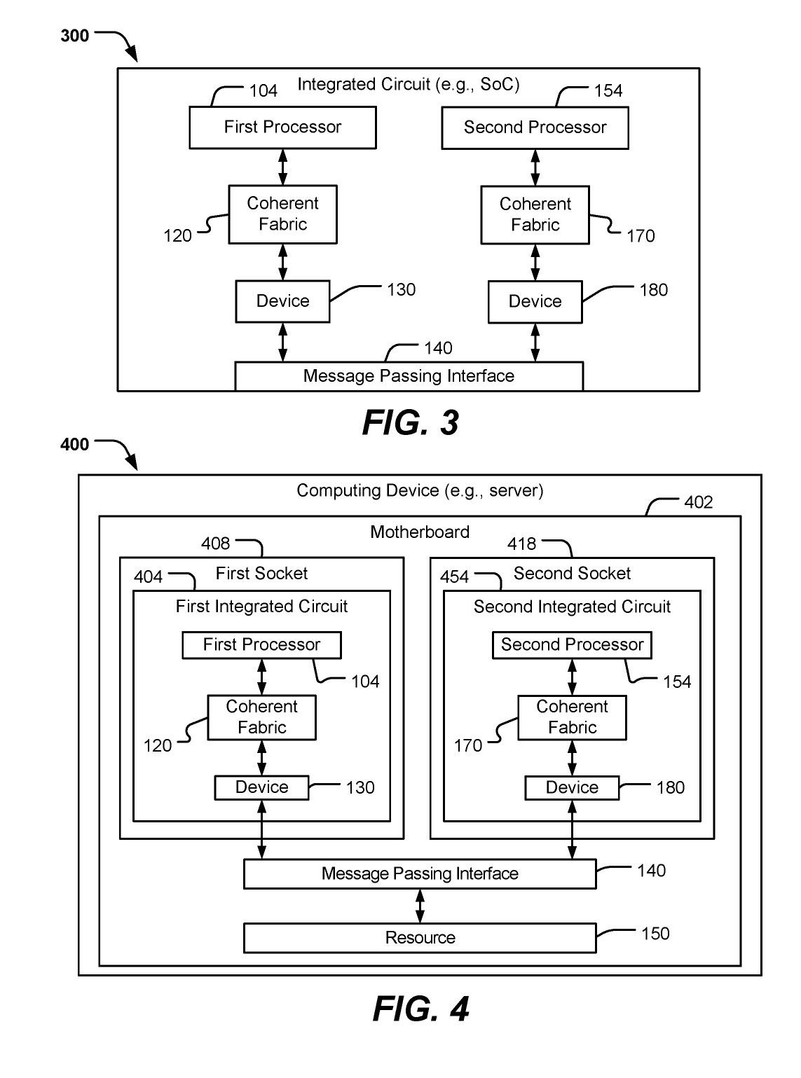

FIG. 3 depicts an illustrative example of an integrated circuit 300. The integrated circuit 300 may correspond to a system-on-chip (SoC) device, as an illustrative example.

The integrated circuit 300 may include the first processor 104 and the second processor 154. Although certain examples are described herein with reference to two processors, in other implementations, a device may include a different number of processors (e.g., one processor, three processors, four processors, or another number of processors).

The integrated circuit 300 also includes the coherent fabrics 120, 170, the devices 130, 180, and the message passing interface 140. The first processor 104, the coherent fabric 120, and the device 130 may be included in the first coherency domain 102, and the second processor 154, the coherence fabric 170, and the device 180 may be included in the second coherency domain 152. In the example of FIG. 3, the message passing interface 140 may correspond to an I/O interface of the integrated circuit 300. The device 130 may be configured to receive requests for access to the resource 150 from the first processor 104, and the device 180 may be configured to receive requests for access to the resource 150 from the second processor 154.

FIG. 4 depicts an illustrative example of a computing device 400. The computing device 400 may correspond to a server, a desktop computer, or a laptop computer, as illustrative examples.

The computing device 400 may include a motherboard 402 having one or more sockets (or slots), such as a first socket 408 and a second socket 418. The first socket 408 may correspond to the first coherency domain 102, and the second socket 418 may correspond to the second coherency domain 152.

The first socket 408 may be configured to receive a first integrated circuit 404, and the second socket 418 may be configured to receive a second integrated circuit 454. In the illustrative example of FIG. 4, the first integrated circuit 404 includes the first processor 104, the coherent fabric 120, and the device 130. FIG. 4 also depicts that the second integrated circuit 454 includes the second processor 154, the coherent fabric 170, and the device 180.

The computing device 400 may further include the resource 150. The integrated circuits 404, 454 may be coupled to the resource 150. For example, the integrated circuits 404, 454 may be coupled to the resource 150 via the message passing interface 140. In some implementations, the message passing interface 140 may include one or more components of the motherboard 402. For example, the message passing interface 140 may include or may correspond to a slot of the motherboard 402, and the resource 150 may be attached to the slot.

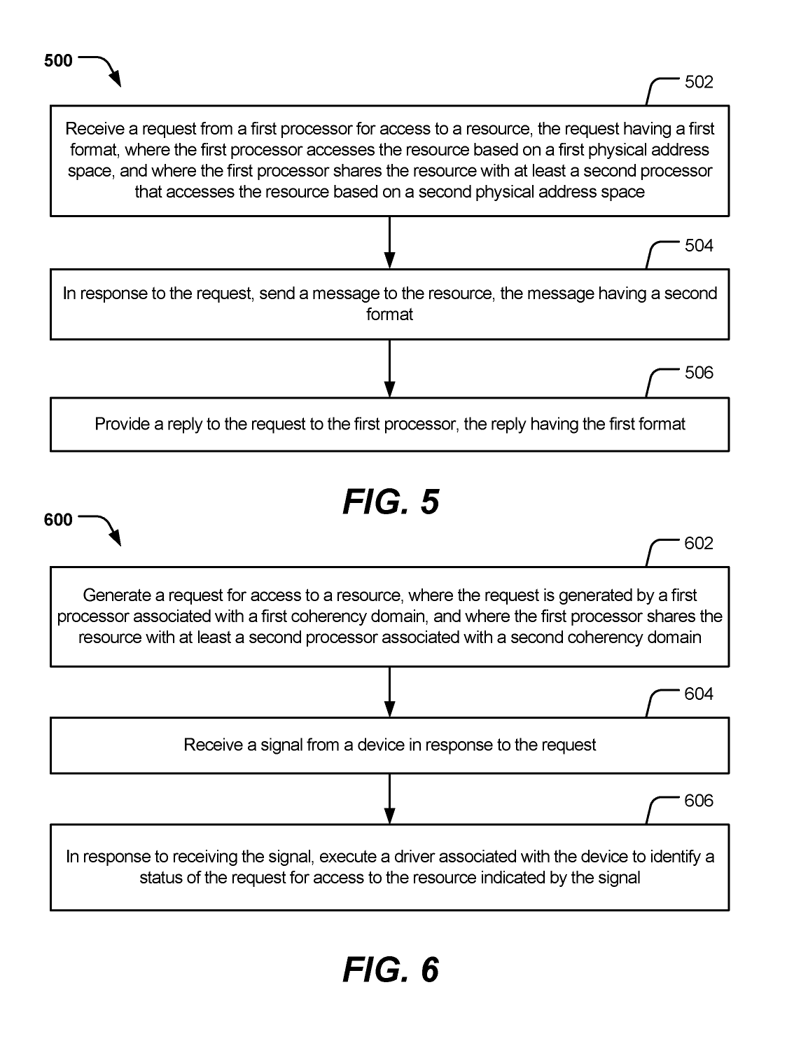

FIG. 5 depicts an illustrative example of a method 500 of operation of a device. For example, the method 500 may be performed by the device 130.

The method 500 includes receiving a request from a first processor for access to a resource, at 502. For example, the device 130 may receive the request 118 (e.g., via the coherent fabric 120) from the first processor 104, and the request 118 may indicate access to the resource 150. The request has a first format (e.g., a format associated with the coherent fabric 120). The first processor accesses the resource based on a first physical address space (e.g., the first physical address space 105), and the first processor shares the resource with at least a second processor (e.g., the second processor 154) that accesses the resource based on a second physical address space (e.g., the second physical address space 155). For example, the first processor 104 may be associated with the first coherency domain 102, and the first processor 104 may share the resource 150 with at least the second processor 154 of the second coherency domain 152.

The method 500 further includes sending a message to the resource in response to the request, at 504. The message has a second format, such as a format associated with the message passing interface 140. For example, the device 130 may send the message 132 to the resource 150 via the message passing interface 140.

The method 500 further includes providing a reply to the request to the first processor, at 506. The reply has the first format. To illustrate, the device 130 may provide the reply 124 to the first processor 104 in response to the request 118. In an illustrative example, the method 500 further includes generating the reply 124 based on a communication (e.g., the reply 134) received from the resource controller 236 (e.g., by reformatting the reply 134 from the second format to the first format to generate the reply 124).

FIG. 6 depicts an illustrative example of a method 600 of operation of a processor. For example, the method 600 may be performed by the first processor 104 or by the second processor 154.

The method 600 includes generating a request for access to a resource, at 602. The request is generated by a first processor associated with a first coherency domain, and the first processor shares the resource with at least a second processor associated with a second coherency domain. For example, the first processor 104 may generate the request 118 for access to the resource 150. The first processor 104 may be associated with the first coherency domain 102, and the first processor 104 may share the resource 150 with the second processor 154 of the second coherency domain 152.

The method 600 further includes receiving a signal from a device in response to the request, at 604. For example, the first processor 104 may receive the signal 122 from the device 130 in response to the request 118.

The method 600 further includes executing, in response to receiving the signal, a driver associated with the device to identify a status of the request for access to the resource indicated by the signal, at 606. For example, the first processor 104 may execute the driver 116 to decode the signal 122 to determine a status of the request 118, such as a “wait” status due to a prior access to the resource 150 by the second processor 154, as an illustrative example.

In connection with the described examples, a computer-readable storage device (e.g., a non-transitory computer-readable medium) stores instructions (e.g., the operating system 114) executable by a processor (e.g., the first processor 104) to perform operations. The operations include generating a request for access to a resource, such as the request 118 for access to the resource 150. The request is generated by a first processor (e.g., the first processor 104) associated with a first coherency domain (e.g., the first coherency domain 102), and the first processor shares the resource with at least a second processor (e.g., the second processor 154) associated with a second coherency domain (e.g., the second coherency domain 152). The operations further include receiving a signal (e.g., the signal 122) from a device (e.g., the device 130) in response to the request. The operations also include executing a driver (e.g., the driver 116) associated with the device to receive the signal and to identify a status of the request for access to the resource indicated by the signal.

One or more hardware components may be used to perform one or more operations of the method 500 of FIG. 5, one or more operations of the method 600 of FIG. 6, one or more other operations described herein, or a combination thereof. As a non-limiting illustrative example, the device 130 may perform one or more operations of the method 500 using one or more hardware components, such as a set of configuration registers included in the emulation engine 220, as described with reference to FIG. 2.

Alternatively or in addition, instructions may be executed to perform one or more operations of the method 500 of FIG. 5, one or more operations of the method 600 of FIG. 6, one or more other operations described herein, or a combination thereof. As a non-limiting illustrative example, the microprocessor 224 may be configured to execute instructions (e.g., the emulation program 226) to perform one or more operations, such as to perform a message reformatting operation, or to perform an address translation operation, to perform one or more other operations, or a combination thereof.

A device or component described herein may be represented using data. As an example, an electronic design program may specify a group of components to enable a user to design an integrated circuit that includes one or more components described herein. Data representing such components may be provided to a circuit designer to design a circuit, to a physical layout creator that designs a physical layout for the circuit, to a semiconductor foundry (or “fab”) that fabricates integrated circuits based on the physical layout, to a testing entity that tests the integrated circuits, to a packaging entity that incorporates the integrated circuits into packages, to an assembly entity that assembles packaged integrated circuits onto printed circuit boards (e.g., onto motherboards), to an assembly entity that assembles printed circuit boards and/or other components into electronic devices (e.g., the system 100 of FIG. 1), to one or more other entities, or a combination thereof. Examples of electronic devices (e.g., the system 100) include computers (e.g., servers, desktop computers, laptop computers, and tablet computers), phones (e.g., cellular phones and landline phones), network devices (e.g., base stations and access points), communication devices (e.g., modems, routers, and switches), and vehicle control systems (e.g., an electronic control unit (ECU) of a vehicle or an autonomous vehicle, such as a drone or a self-driving car), and healthcare devices, as illustrative examples.

The abstract and the summary are provided for convenience and not intended to limit the scope of the claims. Further, the examples described above with reference to FIGS. 1-6 are provided for illustration and are not intended to be limiting. Although certain examples have been described separately for convenience, aspects of the disclosure may be combined without departing from the scope of the disclosure. Those of skill in the art will appreciate that modifications to the examples may be made without departing from the scope of the disclosure.

What is claimed is:

1. A system comprising:
a resource;
a first processor configured to access the resource based on a first physical address space and to generate a request for access to the resource, the request having a first format;
a second processor configured to access the resource based on a second physical address space; and
a device coupled to the resource and to the first processor, the device configured to receive the request, to generate a message having a second format based on the request, to send the message to the resource, and to provide a reply to the request to the first processor.

2. The system of claim 1, wherein the device is further configured to perform a remapping operation to enable the first processor to access the resource based on the first physical address space.

3. The system of claim 2, wherein the device is further configured to map a first address indicated by the request to a second address associated with the resource.

4. An apparatus comprising:
a first processor configured to access a resource based on a first physical address space and to generate a request for access to the resource, the request having a first format; and
a device coupled to the first processor, the device configured to receive the request, to generate a message having a second format based on the request, to send the message to the resource, and to provide a reply to the request to the first processor,
wherein the device is further configured to enable access to the resource by the first processor, and wherein the resource is further accessible by a second processor based on a second physical address space.

5. The apparatus of claim 4, wherein the request has a first packet size associated with the first format, and wherein the message has a second packet size associated with the second format, the second packet size different than the first packet size.

6. The apparatus of claim 4, wherein the request complies with a first command protocol associated with the first format, and wherein the message complies with a second command protocol associated with the second format, the second command protocol different than the first command protocol.

7. The apparatus of claim 4, wherein the request indicates a first address, and wherein the device is further configured to remap the first address to generate a second address included in the message.

8. The apparatus of claim 4, wherein the device is configured to emulate the resource using one or more hardware components.

9. The apparatus of claim 8, wherein the one or more hardware components include a first set of configuration registers corresponding to a second set of configuration registers included in the resource.

10. The apparatus of claim 9, wherein the first processor is further configured to program the first set of configuration registers using the request, and wherein the device is further configured to program the second set of configuration registers by sending the message in response to programming of the first set of configuration registers.

11. The apparatus of claim 4, wherein the device includes a microprocessor configured to execute instructions to emulate one or more operations of the resource.

12. The apparatus of claim 4, wherein the resource includes one or more of a shared memory, a solid state drive (SSD), a hard disk drive (HDD), a hybrid drive, a network interface controller (NIC), a direct memory access (DMA) resource, or a configuration register.

13. The apparatus of claim 4, wherein the request indicates a physical address of the resource.

14. The apparatus of claim 4, wherein the first processor is further configured to execute a driver to receive a signal from the device.

15. The apparatus of claim 14, wherein the driver is executable by the first processor to cause the first processor to enter a sleep mode in response to the signal.

16. The apparatus of claim 14, wherein the signal indicates to an operating system of the first processor that the first processor is to wait to access the resource, to perform a context switch while waiting to access the resource, or both.

17. The apparatus of claim 4, further comprising an integrated circuit that includes the first processor, the second processor, and the device, wherein the device is further configured to receive requests for access to the resource from the second processor.

18. The apparatus of claim 4, further comprising a motherboard that includes a first socket configured to receive a first integrated circuit including the first processor and the device and that further includes a second socket configured to receive a second integrated circuit that includes the second processor.

19. A method comprising:
receiving a request from a first processor for access to a resource, the request having a first format, wherein the first processor accesses the resource based on a first physical address space, and wherein the first processor shares the resource with at least a second processor that accesses the resource based on a second physical address space;
in response to the request, sending a message to the resource, the message having a second format; and
providing a reply to the request to the first processor, the reply having the first format.

20. The method of claim 19, further comprising generating the reply based on a communication received from a resource controller, the communication having the second format.
